(19) United States
(12) Patent Application Publication
(10) Pub. No.: US 2021/0142807 A1
(43) Pub. Date: May 13, 2021

(54) CALL CENTER CONVERSATIONAL CONTENT DISPLAY SYSTEM, METHOD, AND PROGRAM

(71) Applicant: OPTIM CORPORATION, Saga (JP)

(72) Inventor: Shunji SUGAYA, Tokyo (JP)

(21) Appl. No.: 16/623,174

(22) PCT Filed: Jun. 29, 2017
(86) PCT No.: PCT/JP2017/024018

§ 371 Date: Dec. 16, 2019

(51) Int. Cl. G10L 17/22; G06F 40/166; G10L 17/14; H04M 3/51

(52) U.S. Cl. CPC G10L 17/22; H04M 3/5191; G10L 17/14; G06F 40/166

(57) ABSTRACT

Provided is a system that reduces the number of inquiries made to the call center and lightens the burden on the customer service staff. In this call center conversational content display system, a control unit executes an acquisition module to acquire voice data of conversational content between a user and a customer service staff. Next, the control unit executes a conversion module to convert the voice data into text. Then, the control unit executes a disclosure module to enable the text to be displayed on a user terminal in the form of a chat between the user and the customer service staff.

### TECHNICAL FIELD

The present invention relates to a call center conversational content display system, method and program.

### BACKGROUND

In the past, it is known that a call center system that receives and responds to a phone call from a user, and this call center system includes a call recording device and a call recording database. The call recording device is configured to record content of a call between the user and a customer service staff, and the call recording database is configured to store the content of the call by associating the user and the customer service staff (see Patent Document 1).

### PRIOR ART DOCUMENTS

### Patent Documents

Patent Document 1: Japanese Patent Publication No. JP2013-077923.

### SUMMARY

### Problems to be Solved in the Present Invention

However, the above system only stores the content of the call in the call recording database, but does not implement the improvement of reducing the number of inquiries made to the call center and lightening the burden on the customer service staff

Therefore, the object of the present invention is to provide a system that can reduce the number of inquiries made to the call center and lighten the burden on the customer service staff.

### Solution to Solve the Problem

The present invention provides solutions described below.

The invention of a first feature provides a call center conversational content display system that displays conversational content between a user and a customer service staff in a call center in a form of chart. The call center conversational content display system is provided with: an acquisition unit, which is configured to acquire voice data of the conversational content between the user and the customer service staff; a conversion unit, which is configured to convert the voice data into text; and a display unit, which is configured to display the text in the form of a chat between the user and the customer service staff.

According to the invention of the first feature, the conversational content between the user and the customer service staff in the call center is displayed on the display unit in the form of chat. For a questioner who wants to make certain inquiries to the call center, the questioner sometimes can resolve questions in the inquiries at the time of confirming the display of the display unit before inquiring to the call center. In this case, it is unnecessary to directly inquire customer service staffs of the call center.

Therefore, according to the above system, the number of inquiries made to the call center can be reduced and the burden on the customer service staff can be lightened.

The invention of a second feature provides a call center conversational content display system. This system is the invention of the first invention and is further provided with an identification unit which is configured to identify a speaker of the voice data; where the display unit displays the text in the form of a chat between the user and the customer service staff according to a result of the identification.

According to the invention of the second feature, questions in the inquires can be resolved in the form of Question and Answer (Q&A) between the user and the customer service staff, so it takes consideration into that the questioner who wants to make certain inquiries to the call center can get the feeling as if he is asking the call center. Therefore, the positiveness of using the display of the display unit to conduct inquires before directly inquiring the customer service staff is improved, and as a result, the number of inquiries made to the call center is further reduced, and the burden on the customer service staff is further lightened.

The invention of a third feature provides a call center conversational content display system. This system is the invention of the first or second invention and is further provided with a classification unit which is classify the text into questions and answers, where the display unit displays the text in the form of a chat between the user and the customer service staff according to a result of the classification.

According to the invention of the third feature, the area for displaying questions and the area for displaying answers become clear, and the convenience of the above system for the questioner who considers making some inquires to the call center is improved. Therefore, the positiveness of using the display of the display unit to conduct inquires before directly inquiring the customer service staff is improved, and as a result, the number of inquiries made to the call center is further reduced, and the burden on the customer service staff is further lightened.

The invention of a fourth feature provides a call center conversational content display system. This system is the invention of any one of first to third features and is further provided with: a selection unit, which is configured to select the conversational content to be disclosed on a Web page; and a disclosure unit, which is configured to disclose the selected conversational content by loading the selected conversational content on a Web page.

According to the invention of the fourth feature, only the conversational content suitable for wide disclosure is disclosed, and therefore, conversations requiring privacy care, conversations unsuitable for being disclosed and the like can be prevented from being disclosed. Therefore, it prevents the user from becoming embarrassed to inquiry to the customer service staff directly.

The invention of a fifth feature provides a call center conversational content display system. This system is the invention of any one of first to fourth features, where he display unit deletes and displays text in the text converted by the conversion unit which corresponds to information that a viewer of the display unit does not need.

According to the invention of the fifth feature, information that the viewer viewing the display unit does not need is not displayed such that visual confirmation for the viewer is improved. Therefore, the positiveness of using the display of the display unit to conduct inquires before directly inquiring the customer service staff is improved, and as a result, the number of inquiries made to the call center is further reduced, and the burden on the customer service staff is further lightened.

### Invention Effect

According to the present invention, a system that can reduce the number of inquiries made to the call center and lighten the burden on the customer service staff is provided.

### BRIEF DESCRIPTION OF DRAWINGS

FIG. 1 is a block diagram illustrating hardware configuration and software functions of a call center conversational content display system 1 in an embodiment of the present invention.

FIG. 2 is a flowchart illustrating a call center conversational content display method in an embodiment of the present invention.

FIG. 3 is a schematic configuration of a voice text storage area 33 in an embodiment of the present invention.

FIG. 4 is an example of temporarily displaying the text in a form of chat on a customer service staff terminal 2.

FIG. 5 is an example following FIG. 4.

FIG. 6 is an example following FIG. 5.

FIG. 7 is an example of officially displaying the text in a form of chat on a user terminal 3.

FIG. 8 is a block diagram illustrating hardware configuration and software functions of a call center conversational content display system 100 in a variation embodiment of the present invention.

FIG. 9 is a flowchart illustrating a call center conversational content display method in a variation embodiment of the present invention.

FIG. 10 is a schematic configuration of a voice text storage area 33 in a variation embodiment of the present invention.

FIG. 11 is an example following FIG. 6.

FIG. 12 is an example following FIG. 11.

FIG. 13 is an example of officially displaying the text in a form of chat on a user terminal 3.

### DETAILED DESCRIPTION

Embodiments for implementation of the present invention will now be explained with reference to the drawings. It is to be noted that the embodiments are illustrative only, and the scope of the present invention is not limited thereto.

### Configuration of a Call Center Conversational Content Display Ssystem 1

FIG. 1 is a block diagram illustrating hardware configuration and software functions of a call center conversational content display system 1 in an embodiment of the present invention.

The call center conversational content display system 1 is provided with: a control unit 10 for controlling data, a communication unit 20 for communicating with other devices and a storage unit 30 for storing the data.

The control unit 10 is provided with a central processing unit (CPU), a random access memory (RAM), a read-only memory (ROM) and the like.

The control unit 10 reads a prescribed program and cooperates with the communication unit 20 according to requirements, so as to implement an acquisition module 11, a conversion module 12, a identification module 13, a temporary display module 14, a deletion module 15, a selection module 16 and a disclosure module 17.

The communications unit 20 is provided with devices capable of communicating with other devices.

The storage unit 30 is a device storing data and files, and the storage unit 30 is provided with a data storage unit implemented by a hard disk, a semiconductor memory, a recording medium, a storage card, etc. The storage unit 30 stores a voice data storage area 31, a dictionary database 32, a voice text storage area 33, a voiceprint storage area 34, a deletion information database 35 and a mosaic information database 36 to be described later.

### Flowchart Illustrating a Call Center Conversational Content Display Method Using the Call Center Conversational Content Display System 1

FIG. 2 is a flowchart illustrating a call center conversational content display method using the call center conversational content display system 1. The processing executed by various hardware and software modules described above will be described below.

Step S11: acquiring voice data of conversational content.

First, a control unit 10 of the call center conversational content display system 1 executes an acquisition module 11 to acquire voice data of conversational content between a user and a customer service staff in a call center (step S11).

The call center conversational content display system 1 is in the network connection to a customer service staff terminal 2 used by the customer service staff in the call center via the communication unit 20. When voice data transmitted from a user terminal 3 used by a user in the call center is input to the customer service staff terminal 2, the voice data is input to the call center conversational content display system 1 via the communication unit 20. In addition, the voice from the customer service staff in the call center is also converted into voice data by the A/D in the terminal used by the customer service staff. The voice data converted by the A/D is also input to the call center conversational content display system 1 via the communication unit 20.

The voice data input to the call center conversational content display system 1 is stored in the voice data storage area 31 of the storage unit 30 together with information on call date and time.

It is to be noted that timing of storing voice data in the voice data storage area 31 is not particularly limited. For example, the conversational content of the user and the customer service staff in the call center may also be temporarily stored in the terminal on the customer service staff side, and after the conversation between the user and the customer service staff ends, the conversational content is sent to the call center conversational content display system 1 from the terminal on the customer service staff side together with voice data. In an example, the voice data may be sent from the terminal on the customer service staff side to the call center conversational content display system 1 at any time during the conversation between the user and the customer service staff in the call center.

Step S12: converting the voice data into text.

Then, the control unit 10 executes the conversion module 12, and converts the voice data acquired in the processing of step S11 into text (step S12).

The technology of converting voice data into text may be the voice identification technology that has already been well known. For example, a technique that converts voice stored in the voice data storage area 31 into phonemes of words and outputs the closest article as text with reference to the dictionary database 32 predisposed in the storage unit 30 may be enumerated.

The output text is stored in the voice text storage area 33 of the storage unit 30.

FIG. 3 is an example of configuration of the voice text storage area 33. The voice text storage area 33 is configured to include the following items: call time and call date, speakers, voice text, and a flag for identifying whether the content of the voice text is suitable for display or not. At the stage of step S12, the speaker cannot be determined. In addition, at the stage of step S12, whether the content of the voice text is suitable for display or not cannot be identified either. Therefore, at the stage of step S12, only the call date and time and the information of the voice text are stored in the voice text storage area 33.

It is to be noted that the following is described in a case of existence of such a conversation between the user and the customer service staff.

User (Taro Yamada, member No.: 123456): There is something wrong with the product A.

Customer service staff (Suzuki Hanako, staff No.: 0234): Please tell me your mane and member number.

User: 123456, Taro Yamada.

Customer service staff: The product A needs to be repaired, so could you mail it to us?

User: Okay. I'll mail it tomorrow.

User: Well, goodbye! After that, the conversation ends.

(Step S13: identifying a speaker of the voice data)

See FIG. 2. Then, the control unit 10 execute the identification module 13, and identifies the speaker of the voice data acquired in the processing of step S11 (step S13).

The technology of identifying speakers may be the speaker identification technology that has already been well known. For example, a technique that extracts features from a voice stored in the voice data storage area 31 and models the features to identify an individual's voice may be enumerated.

First, features are extracted from the voice of the customer service staff in advance to construct a model of voiceprint. The constructed voiceprint is stored in the voiceprint storage area 34 of the storage unit 30.

Then, for the voice data acquired in the processing of step S11, whether the voice data is consistent with the voice of the model stored in the voiceprint storage area 34 is determined. In a case of consistency, the control unit 10 identifies that the speaker of this voice data is a customer service staff while in a case of inconsistency, the control unit 10 identifies that the speaker of this voice data is a user.

It is to be noted that, for voice data of the speaker identified as a user (in this embodiment, Taro Yamada, member No.: 123456), features may be extracted and a voiceprint model may be constructed, and the constructed voiceprint may be stored in the voiceprint storage area 34 of the storage unit 30 as a voiceprint of Taro Yamada. In this way, in the future, the accuracy of identifying the speaker as Taro Yamada when Taro Yamada makes other inquires can be improved.

In addition, for the customer service staff (in this embodiment, Suzuki Hanako, staff No.: 0234), the accuracy of machine learning can be improved by updating the model of voiceprint.

The result of identifying the speaker is stored in the item of “Speaker” in the voice text storage area 33 of the storage unit 30.

Step S14: temporarily displaying the text in a form of chat

The control unit 10 executes the temporary display module 14 to temporarily display the text representing the conservation between the user and the customer service staff in a form of chat on a customer service staff terminal 2 (step S14).

FIG. 4 is an example of temporary display on a customer service staff terminal 2. On the left side of the screen, the conversation content of the user is displayed, and on the right side, the conversation content of the customer service staff is displayed. The control unit 10 distinguishes between the voice text in which the speaker is the user and the voice text in which the speaker is the customer service staff with reference to the voice text storage area 30. The voice text of the speaker who is the user is displayed chronologically on the left side of the screen as the conversation content of the user, and the voice text of the speaker who is the customer service staff is displayed chronologically on the right side of the screen as the conversation content of the customer service staff.

Step S15: deleting unnecessary information.

The control unit 10 executes the deletion module 15 to delete the conversational content that is temporarily displayed on the customer service staff terminal 2 and is equivalent to information that is not needed for the viewer when the conversational content is widely and universally disclosed in the future (step S15).

FIG. 5 is an example of temporary display on a customer service staff terminal 2 when the customer service staff clicks “NEXT STEP” in FIG. 4 and the control unit 10 executes the processing of step S15. “Please select the item to be deleted” is displayed on the customer service staff terminal 2. Therefore, when the conversational content is viewed, the conservation “Well, goodbye!” at the bottom of the list is information that is not needed for the viewer in the conversational content that is widely and universally disclosed in the future. Therefore, the conversation “Well, goodbye!” is deleted through the selection operation of the customer service staff.

The result of the selection operation of the customer service staff will be reflected in the information that is displayed/not displayed in the voice text storage area 33 (FIG. 3).

In addition, the result of the selection operation of the customer service staff may be registered in the deletion information database 35 of the storage unit 30, and in the subsequent operation, with reference to the registration content registered in the deletion information database 3, the control unit 10 can propose the item that is predicted to be suitable for deletion to the customer service staff from the call center conversational content display system 1. In this way, the burden on the customer service staff can be further lightened.

Step S16: selecting conversational content to be disclosed.

The control unit 10 executes the selection module 16 to select the conversational content disclosed on a Web page from the conversational content temporarily displayed on the customer service staff terminal 2 (step S16).

In the conversational content temporarily displayed on the customer service staff terminal 2, there is the content that is not hoped to be disclosed on the Web page from the perspective of the privacy of the user.

Therefore, the storage unit 30 is provided with a mosaic information database 36 which pre-stores items related to the privacy of the user, such as user's proprietary terms, user's member numbers and the like. The control unit 10, with reference to the mosaic information database 36, executes the processing of putting mosaics on the items related to the privacy of the user in the conversational content temporarily displayed on the customer service staff terminal 2.

FIG. 6 is an example of temporary display on a customer service staff terminal 2 when the customer service staff clicks “NEXT STEP” in FIG. 5 and the control unit 10 executes the processing of step S16. “Please select the position to be mosaic” is displayed on the customer service staff terminal 2. This is to prevent the information related to the privacy of the user from being mistakenly disclosed in the case of insufficient mosaic processing. Therefore, the customer service staff is allowed to put mosaics.

In addition, the mosaics processing is pre-applied to the proprietary terms and the member number of Taro Yamada. In this embodiment, the customer service staff does not need to manually implement the mosaic processing, thereby further lightening the burden on the customer service staff.

It is to be noted that in a case that the customer service staff manually implements the mosaic processing, the content is registered in the mosaic information database 36 of the storage unit 30 and is reflected in the subsequent operations.

The result of the selection operation of the customer service staff will be reflected in the information that is displayed/not displayed in the voice text storage area 33 (FIG. 3).

Step S17: disclosing the text on the Web page.

The control unit 10 executes the disclosure module 17 to widely and universally disclose the conversational content of the user and the customer service staff in a form of chat between the user and the customer service staff (step S17).

FIG. 7 is a display example on a user terminal 3 when the conversational content is widely and universally disclosed. Therefore, the content can be viewed on the user terminal 3.

According to the invention described in this embodiment, the conversational content between the user and the customer service staff in the call center is displayed on the user terminal 3. For a questioner who wants to make certain inquiries to the call center, the questioner sometimes can resolve questions in the inquiries at the time of confirming the display of the display module before inquiring to the call center. In this case, it is unnecessary to directly inquire customer service staffs of the call center. Therefore, according to the above system, the number of inquiries made to the call center can be reduced and the burden on the customer service staff can be lightened according to the call center conversational content display system 1 described in this embodiment.

The control unit 10 executes the identification module 13 to identify the speaker of the voice data. According to the invention of the second feature, questions in the inquires can be resolved in the form of Question and Answer (Q&A) between the user and the customer service staff, so it takes consideration into that the questioner who wants to make certain inquiries to the call center can get the feeling as if he is asking the call center. Therefore, the positiveness of using the display of the display module to conduct inquires before directly inquiring the customer service staff is improved, and as a result, the number of inquiries made to the call center is further reduced, and the burden on the customer service staff is further lightened.

In addition, the control unit 10 executes the selection module 16 to select the conversational content to be disclosed on the Web page, and executes the disclosure module 17 to disclose the conversational content selected in the processing of the selection module 16 by loading the selected conversational content on the Web page. Therefore, only the conversational content suitable for wide disclosure is disclosed, and thus conversations requiring privacy care, conversations unsuitable for being disclosed and the like can be prevented from being universally disclosed. Therefore, it prevents the user from becoming embarrassed to inquiry to the customer service staff directly.

In addition, the control unit 10 executes the selection module 16 to delete and display text that is equivalent to information that is not needed for the viewer in the text converted through the execution of the conversion module 12. Therefore, information that the viewer viewing the display module does not need is not displayed such that visual confirmation for the viewer is improved. Therefore, the positiveness of using the display of the display module to conduct inquires before directly inquiring the customer service staff is improved, and as a result, the number of inquiries made to the call center is further reduced, and the burden on the customer service staff is further lightened.

### Variation Example

In the above embodiments, the conversational content between the user and the customer service staff may be displayed in a form of conversation using dialogue boxes, but is not limited thereto. For example, conversations equivalent to questions and conversations equivalent to answers may be distinguished and displayed in a Q&A form.

FIG. 8 illustrates configuration of a call center conversational content display system 100 in this case. The difference between this system 100 and the system 1 described in FIG. 1 is that in this system, the control unit 10 is provided with a classification module 118. Beyond that, this system 100 is the same as the system 1 described in FIG. 1.

FIG. 9 illustrates a flowchart of a call center conversational content display method in this case. The difference between this method and the method described in FIG. 2 is that in this method, the processing of “classifying the text into questions and answers S118” is implemented between steps S17 and S18. Beyond that, this method is the same as the method described in FIG. 2.

Step S118: classifying the text into questions and answers.

After the processing of step S17, the control unit 10 executes the classification module 118 to classify the conversational content between the user and the customer service staff into questions and answers (step S118).

FIG. 11, following FIG. 6, is an example of temporary display on the customer service staff terminal 2. For each conversation content, whether it corresponds a “question” or an “answer” is selected.

The result of the selection operation of the customer service staff will be reflected in the flags of “question/answer” in the voice text storage area 33 (FIG. 10) of the variation example. The difference between FIG. 10 and FIG. 3 is that in FIG. 10, flags of “question/answer” are added, and beyond that, FIG. 10 is the same as FIG. 3.

The control unit 10 classifies the conversational content into questions and answers, and reconstructs and displays the questions and answers.

FIG. 12, following FIG. 11, is an example of temporary display on the customer service staff terminal 2. The content equivalent to questions is collected on the upper segment, and the content equivalent to answers is collected on the lower segment. A bottom “DISCLOSE” is disposed on the lower right of the temporary display example. When the customer service staff clicks the bottom “DISCLOSE”, the control unit 10 executes the processing of step S17.

Step S17: disclosing the text on the Web page.

The control unit 10 executes the disclosure module 17 to widely and universally disclose the conversational content of the user and the customer service staff in a form of chat between the user and the customer service staff (step S17).

FIG. 13 is a display example on a user terminal 3 when the conversational content is widely and universally disclosed. Therefore, the content can be viewed on the user terminal 3.

According to the invention is this variation example, the area for displaying questions and the area for displaying answers become clear, and the convenience of the above system for the questioner who considers making some inquires to the call center is improved. Therefore, the positiveness of using the display of the display module to conduct inquires before directly inquiring the customer service staff is improved, and as a result, the number of inquiries made to the call center is further reduced, and the burden on the customer service staff is further lightened.

The above modules and functions described above are implemented when a computer (including a CPU, an information processing device and various terminals) reads and executes a prescribed program. The program is provided by being recorded in a computer-readable recording medium such as a soft disc, a CD (CD-ROM, etc.), a DVD (DVD-ROM, DVD-RAM, etc.) and the like. In this case, the computer reads the program from the recording medium, transfers the program to an internal storage device or an external storage device, and stores and executes the program. In addition, the program may also be pre-recorded in a storage device (recording medium) such as a magnetic disk, an optical disk and a magneto-optical disk, and provided to the computer from the storage device via a communication line.

The embodiments of the present invention have been described above, but the present invention is not limited to these embodiments. In addition, the effects described in the embodiments of the present invention are merely examples of the best effects produced by the present invention, and the effects of the present invention are not limited to the effects described in the embodiments of the present invention.

### DESCRIPTION OF THE REFERENCE NUMERALS

1 call center conversational content display system

10 control unit;

11 acquisition module;

12 conversation module;

13 identification module;

14 temporary display module;

15 deletion module;

16 selection module;

17 disclosure module;

20 communication unit;

30 storage unit;

31 voice data storage area;

32 dictionary database;

33 voice text storage area;

34 voiceprint storage area;

35 deletion information database;

36 mosaic information database;

2 customer service staff; and

3 user terminal.

1. A call center conversational content display system, which is configured to display conversational content between a user and a customer service staff in a call center in a form of chat, comprising:
an acquisition unit, which is configured to acquire voice data of the conversational content between the user and the customer service staff;
a conversion unit, which is configured to convert the voice data into text;
an identification unit, which is configured to identify a speaker of the voice data; and
a display unit, which is configured to display the text in the form of a chat between the user and the customer service staff according to a result of the identification.

2-3. (canceled)

4. The call center conversational content display system of claim 1, further comprising:
a selection unit, which is configured to select the conversational content to be disclosed on a Web page; and
a disclosure unit, which is configured to disclose the selected conversational content by loading the selected conversational content on the Web page.

5. The call center conversational content display system of claim 1, wherein
the display unit is configured to delete text from the text converted by the conversion unit which corresponds to information that a viewer of the display unit does not need and display text excluding the deleted text in the text converted by the conversion unit.

6. A call center conversational content display method, which is applied to display conversational content between a user and a customer service staff in a call center in a form of chat, comprising:
a step of acquiring voice data of the conversational content between the user and the customer service staff;
a step of converting the voice data into text;
a step of identify a speaker of the voice data; and
a step of displaying the text in the form of a chat between the user and the customer service staff according to a result of the identification.

7. A program, which is configured to enable a call center conversational content display system which displays conversational content between a user and a customer service staff in a call center in a form of chat to execute:
a step of acquiring voice data of the conversational content between the user and the customer service staff;
a step of converting the voice data into text;
a step of identify a speaker of the voice data; and
a step of displaying the text in the form of a chat between the user and the customer service staff according to a result of the identification.

8. The call center conversational content display system of claim 4, wherein
the display unit is configured to delete text from the text converted by the conversion unit which corresponds to information that a viewer of the display unit does not need and display text excluding the deleted text in the text converted by the conversion unit.
